(19) United States
(12) Patent Application Publication
(10) Pub. No.: US 2013/0278498 A1
(43) Pub. Date: Oct. 24, 2013

(54) PRESSURE SENSITIVE TOUCH PANEL AND PORTABLE TERMINAL INCLUDING THE SAME

(71) Applicant: SAMSUNG ELECTRONICS CO., LTD., Gyeonggi-do (KR)

(72) Inventors: Dae-Kwang JUNG, Gyeonggi-do (KR); Kyung-Wan PARK, Gyeonggi-do (KR); Ho-Seong SEO, Gyeonggi-do (KR); Shi-Yun CHO, Gyeonggi-do (KR); Youn-Ho CHOI, Seoul (KR)

(73) Assignee: Samsung Electronics Co., Ltd., Gyeonggi-do (KR)

(21) Appl. No.: 13/865,623

(22) Filed: Apr. 18, 2013

(30) Foreign Application Priority Data
Apr. 18, 2012 (KR) 10-2012-0040250

(51) Int. Cl. G06F 3/041

(52) U.S. Cl. CPC G06F 3/041
USPC 345/156

(57) ABSTRACT

A pressure sensitive touch panel is provided, which includes first sensor lines arranged along a first axis; second sensor lines arranged along a second axis that cross the first axis; a drive unit that sequentially applies a scan signal to the first sensor lines, and sequentially detects detection signals of the second sensor lines; and a controller that controls the drive unit to selectively apply the scan signal to one of the first sensor lines and to selectively detect a detection signal from one of the second sensor lines.

### PRIORITY

This application claims priority under 35 U.S.C. §119(a) to Korean Application Serial No. 10-2012-0040250, which was filed in the Korean Intellectual Property Office on Apr. 18, 2012, the entire content of which is hereby incorporated by reference.

### BACKGROUND OF THE INVENTION

1. Field of the Invention

The present invention relates generally to a touch panel, and more particularly, to a pressure sensitive touch panel and a portable terminal including the pressure sensitive touch panel.

2. Description of the Related Art

Due to the recent advances with the flexible displays, various research is being conducted to provide a touch unit for flexible display devices, which is intuitive and easy to use. Because a touch panel applied to a flexible device should be able to perform as intended and maintain its lifespan, even when bent, rolled, etc., a capacitive touch panel utilizing a flexible electrode and a pressure sensitive touch panel with pressure sensitive resistance is receiving a great deal of attention for the flexible device.

Specifically, because a pressure sensitive touch panel can receive touch inputs from a finger and various types of pens or tools, a more delicate input can be provided. Accordingly, studies and developments for commercialization of pressure sensitive touch panels are actively being conducted.

However, conventional touch panels cannot accurately detect a coordinate of a touch point due to noise input through multiple paths, instead of a single scan path.

### SUMMARY OF THE INVENTION

Accordingly, the present invention is designed to at least partially solve, alleviate, or eliminate at least one of the problems and/or disadvantages of the related art, and to provide at least the advantages described below.

An aspect of the present invention is to provide a voltage scanning method and apparatus for restraining a multiple path effect to minimize an error generated when a touch coordinate is calculated by the multiple path effect in a pressure sensitive touch panel used as an input unit of a flexible device, a touch panel realizing the same, and a portable terminal including the touch panel.

In accordance with an aspect of the present invention, a pressure sensitive touch panel is provided, which includes first sensor lines arranged along a first axis; second sensor lines arranged along a second axis that cross the first axis; a drive unit that sequentially applies a scan signal to the first sensor lines, and sequentially detects detection signals of the second sensor lines; and a controller that controls the drive unit to selectively apply the scan signal to one of the first sensor lines and to selectively detect a detection signal from one of the second sensor lines.

In accordance with another aspect of the present invention, a portable terminal including a pressure sensitive touch panel, which includes first sensor lines arranged along a first axis; second sensor lines arranged along a second axis that cross the first axis; a drive unit that sequentially applies a scan signal to the first sensor lines, and sequentially detects detection signals of the second sensor lines; and a controller that controls the drive unit to selectively apply the scan signal to one of the first sensor lines and to selectively detect a detection signal from one of the second sensor lines.

### BRIEF DESCRIPTION OF THE DRAWINGS

The above and other aspects, features, and advantages of certain embodiments of the present invention will be more apparent from the following detailed description taken in conjunction with the accompanying drawings, in which:

FIG. 1 illustrates a portable terminal according to an embodiment of the present invention;

FIG. 2 illustrates an exploded perspective view of a touch interface according to an embodiment of the present invention;

FIG. 3 illustrates first and second sensor lines of a sensor layer according to an embodiment of the present invention;

FIG. 4 illustrates a principle of detecting a user input by a sensor layer according to an embodiment of the present invention;

FIG. 5A illustrates a circuit configuration according to an embodiment of the present invention;

FIG. 5B illustrates a method of calculating a voltage value of a sensing point according to an embodiment of the present invention;

FIG. 6 illustrates the creation of multiple paths of a single touch according to a comparison example according to an embodiment of the present invention;

FIG. 7 illustrates the creation of multiple paths of multiple touches according to a comparison example according to an embodiment of the present invention;

FIG. 8 illustrates a drive unit according to an embodiment of the present invention;

FIG. 9 illustrates a voltage scanning method according to an embodiment of the present invention;

FIG. 10 illustrates a method of restraining multiple paths of a single touch according to an embodiment of the present invention; and

FIG. 11 illustrates a method of restraining multiple paths of multiple touches according to an embodiment of the present invention.

### DETAILED DESCRIPTION OF EMBODIMENTS OF THE PRESENT INVENTION

Various embodiments of the present invention will now be described in detail with reference to the accompanying drawings. In the following description, specific details such as detailed configuration and components are merely provided to assist the overall understanding of these embodiments of the present invention. Therefore, it should be apparent to those skilled in the art that various changes and modifications of the embodiments described herein can be made without departing from the scope and spirit of the present invention. In addition, descriptions of well-known functions and constructions are omitted for clarity and conciseness.

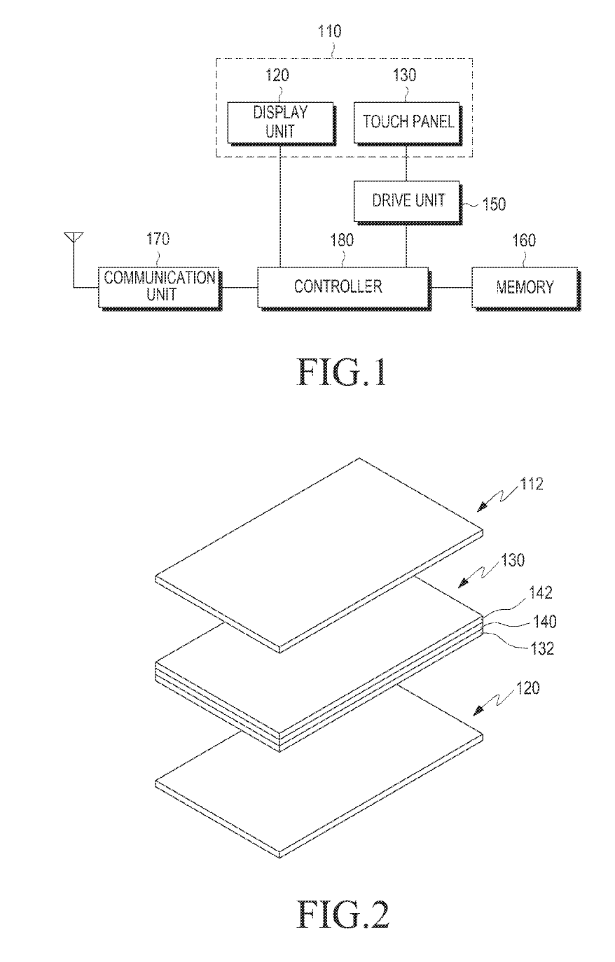

FIG. 1 illustrates a portable terminal according to an embodiment of the present invention.

The portable terminal includes a touch interface (or touch screen) 110 having a display unit 120 and a touch panel 130, a drive unit 150, a memory 160, a communication unit 170, and a controller 180. Although not illustrated, the portable terminal may also include a speaker, a microphone, a camera, etc. For example, the portable terminal may be a camera having a flexible touch interface, a camcorder, a mobile phone, a console, a Personal Digital Assistant (PDA), and a tablet Personal Computer (PC), etc.

The touch interface 110 includes a window, which protects the display unit 120 and the touch panel 130, formed of a synthetic resin such as PolyEthylene Terephthalate (PET) or plastic, and has a flexibility by which the touch interface 110 can be easily bent by a user and a resiliency by which the touch interface 110 returns to its original shape after being bent. The window may be included in the touch panel 130.

The display unit 120 displays an image, and may include a Liquid Crystal Display (LCD), an Organic Light Emitting Diode (OLED), and an LED.

The touch panel 130 may be disposed on or under the display unit 120. Herein, the touch panel 130 is disposed on a front surface of the portable terminal, and the display unit 120 is disposed under the touch panel 130. Alternatively, the display unit 120 may be disposed on the front surface of the portable terminal 100.

The touch panel 130 is a pressure sensitive touch panel, which detects a user input. For example, a user touches various executable items displayed on a screen (that is, a surface of the touch interface 110) of the touch interface 110 to execute an application or a link page related to the items. If a user input unit (for example, a finger or a stylus pen) presses the surface of the touch interface 110, the touch panel 130 outputs an input location (or coordinate) and/or a detection signal (or touch detection signal) having information on an input pressure.

The drive unit 150 drives the touch panel 130 under the control of the controller 180, and outputs the user input information including an input location and/or an input pressure recognized from a detection signal output from the touch panel 130 to the controller 180. Alternatively, the drive unit 150 may be included in the control unit 180 or the touch panel 130, and may convert an analog detection signal input from the touch panel 130 into a digital detection signal to output the digital detection signal to the controller 180. Accordingly, some or all parts of the drive unit 150 may be included in the controller 180 or the touch panel 130.

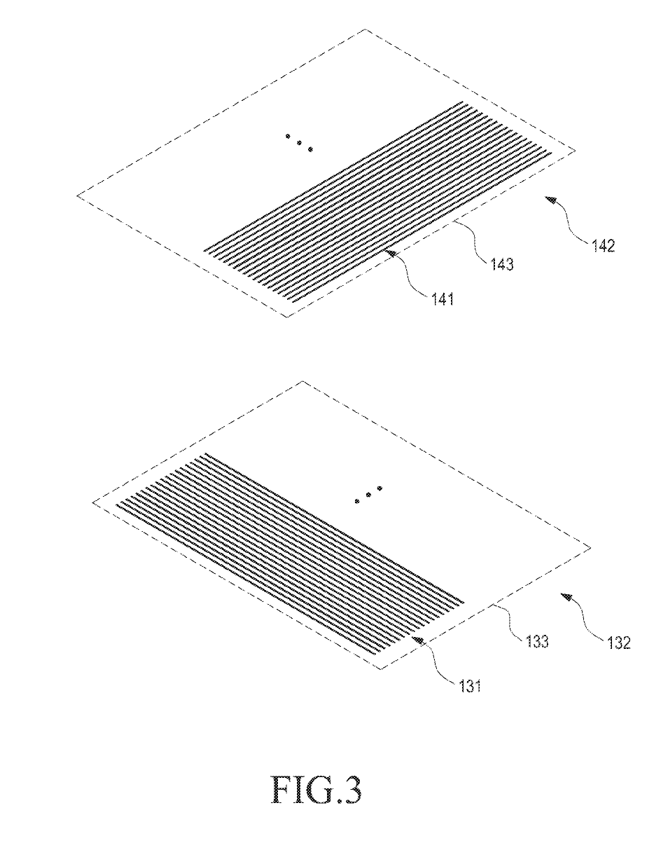

FIG. 2 illustrates an exploded perspective view of a touch interface according to an embodiment of the present invention.

Referring to FIG. 2, in the touch interface 110, the display unit 120, the touch panel 130, and the window 112 are stacked from bottom to top while being attached to each other or partially or entirely spaced apart from each other. The touch panel 130, the display unit 120, and the window 112 have both flexibility and resiliency.

The touch panel 130 includes a sensor layer 140 for recognizing an input location and/or an input pressure of the user input unit, and first and second substrates 132 and 142 stacked on lower and upper surfaces of the sensor layer 140 to support the sensor layer 140.

The sensor layer 140 has a pattern for recognizing an input location and/or an input pressure of the user input unit. For example, the sensor layer 140 may have various patterns such as a linear grid pattern and a diamond pattern.

FIG. 3 illustrates first and second sensor lines constituting a sensor layer according to an embodiment of the present invention.

Referring to FIG. 3, first sensor lines 131 are laminated on an upper surface of the first substrate 132 and second sensor lines 141 are laminated on a lower surface of the second substrate 142 such that the upper surface 133 of the first substrate 132 and the lower surface 143 of the second substrate 142 face each other.

The first sensor lines 131 extend along a first direction (or axis) (for example, the X-axis or a horizontal direction), and are disposed at equal intervals or different intervals along a second direction (or axis) (for example, the Y-axis direction or a vertical direction) perpendicularly crossing the first direction. The second sensor lines 141 extend along the second direction perpendicularly crossing the first direction, and are disposed at equal intervals or different intervals along the first direction.

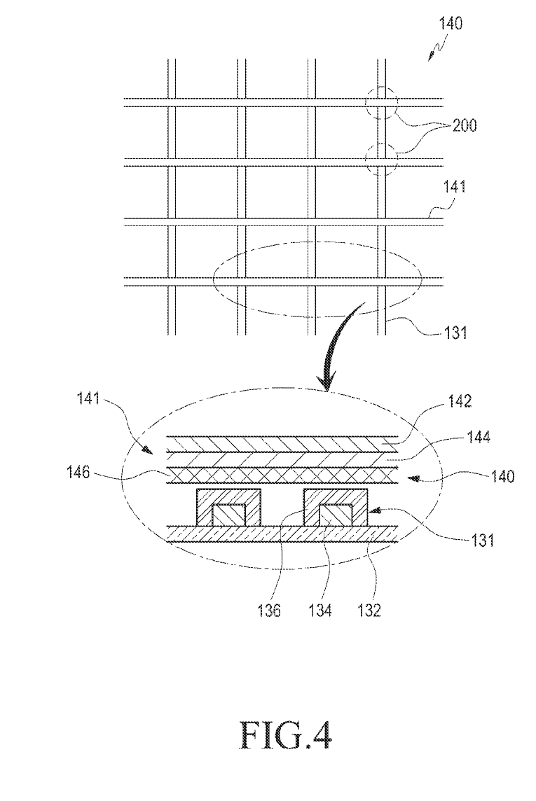

FIG. 4 illustrates a principle of detecting a user input by a sensor layer according to an embodiment of the present invention.

Referring to FIG. 4, the first sensor lines 131 laminated on the upper surface of the first substrate 132 include first electrode lines 134 directly laminated on the upper surface of the first substrate 132, and first resistance layers 136 laminated to surround the exposed outer surfaces of the first electrode lines 134. The second sensor lines 141 laminated on the lower surface of the second substrate 142 include second electrode lines 144 directly laminated on the lower surface of the second substrate 142, and second resistance layers 146 laminated to surround the exposed outer surfaces of the second electrode lines 144. For example, the first and second substrates 132 and 142 may be formed of a synthetic resin such as polyimide or plastic, and the first and second electrode lines 134 and 144 may be formed of a metal such as silver. Further, the first and second resistance layers 136 and 146 may be formed of a resistive material such as carbon, and the first and second resistance layers 136 and 146 may be spaced apart from each other or contact each other, and may have rough surfaces, respectively.

In order to perform the sensor function, voltages (that is, scan signals) of preset waveforms are sequentially applied to the first electrode lines 134, and the second electrode lines 144 output detection signals based on the scan signals. If the user presses the touch panel 130, resistances of contact portions of the first and second contact layers 136 and 146 vary while contact areas of the first and second resistance layers 136 and 146 vary. The voltage waveforms of the detection signals output from the second electrode lines 144 vary based on the resistance variations, and an input location and/or an input pressure of the user input unit are recognized from the detection signals whose voltage waveforms have changed. Points where the first and second sensor lines 131 and 141 cross each other are sensing points 200, which are disposed in a matrix structure in this example. A user input location is determined by one of the locations of the sensing points 200.

Referring again to FIG. 1, the memory 160 stores an operating system of the portable terminal, various applications, information input to the portable terminal, information created in the portable terminal, etc.

The communication unit 170, e.g., a wired or wireless communication unit, transmits data from the controller 180 and receives data from an external source to transmit the data to the controller 180. The communication unit 170 may communicate through wires or wirelessly.

The controller 180 is a central processing unit, which controls the overall operation of the portable terminal.

The drive unit 150 sequentially applies scan signals to the first electrode lines 134 and sequentially scans the second electrode lines 144 to the first electrode lines 134 to which scan signals are applied, to sequentially scan the sensing points 200 disposed in a matrix structure. Here, a scan means to apply and detect of voltages.

The drive unit 150 restrains a multiple path effect in which detection signals having passed through a plurality of sensing points for a single input of a user are created.

The controller 180 or the drive unit 150 determines a touch point or a coordinate thereof based on a difference between a voltage of a scan signal and a voltage of a detection signal.

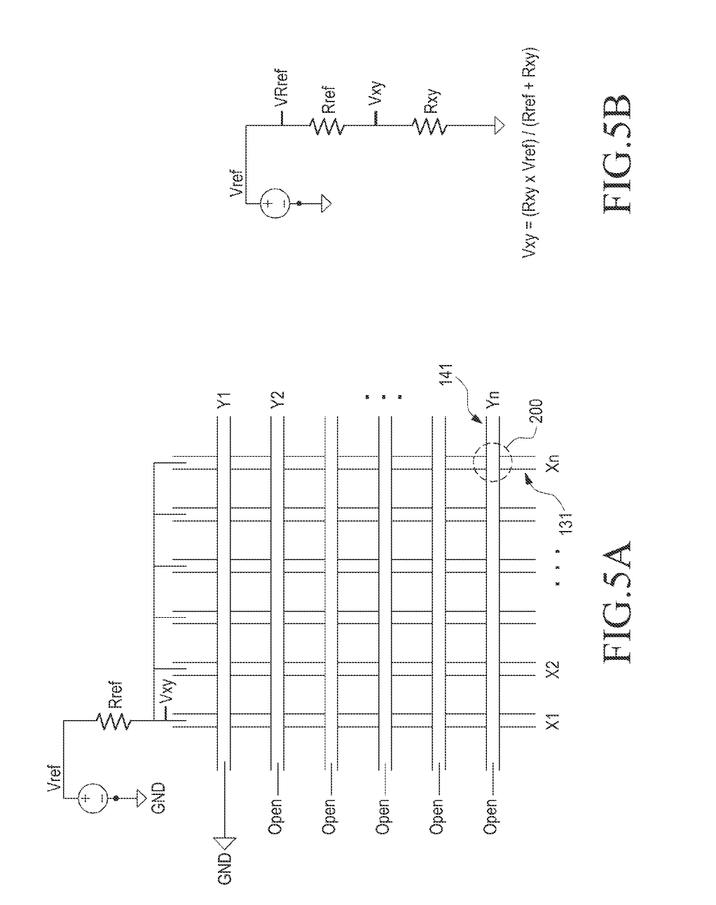

FIG. 5A illustrates a circuit configuration according to an embodiment of the present invention.

In FIG. 5A, the first sensor lines 131 are referred to as first to n-th X-axis sensor lines X1 to Xn according to a sequence of rows, and the second sensor lines 141 are referred to as first to n-th Y-axis sensor lines Y1 to Yn according to a sequence of columns. The sensing points 200 are points (or areas) where the X-axis sensor lines X1 to Xn and the Y-axis sensor lines Y1 to Yn cross each other. A reference voltage Vref is applied to all the X-axis sensor lines X1 to Xn through a reference resistance Rref.

A case of scanning a voltage value Vxy of a sensing point of column 1 and row 1, where the first X-axis sensor line X1 and the first Y-axis sensor line Y1 cross each other is described below.

First, after only the first Y-axis sensor line Y1 is connected to a ground voltage GND which can be defined as zero voltage or the ground which is taken to be at zero voltage and the remaining second to n-th Y-axis sensor lines Y2 to Yn are opened, a voltage value Vxy of the sensing point of column 1 and row 1 is scanned. The voltage applied to the first X-axis sensor line X1 is a scan signal, and a voltage value Vxy output 25 through the first Y-axis sensor line Y1 is a detection signal. The voltage value Vxy at the sensing point is a voltage value other than the voltage value VRref of the reference voltage Rref at the reference voltage Vref. That is, the voltage value Vxy at the sensing point is a voltage value applied to a resistance Rxy at a contract portion between the first and second resistance layers 136 and 146.

Unlike this example, voltage values of sensing points around a touch point to which a touch pressure is transferred may also be scanned, and a coordinate of a touch point may be calculated by computing the voltage values.

FIG. 5B illustrates a method of calculating a voltage value of a sensing point according to an embodiment of the present invention.

Referring to FIG. 5B, a voltage value Vxy of a sensing point is calculated based on a reference voltage Vref, a reference resistance Rref, and a resistance Rxy of a sensing point. For example, the voltage value Vxy may be calculated as shown below in Equation (1).

Vxy=(Rxy×Vref)/(Rref+Rxy) (1)

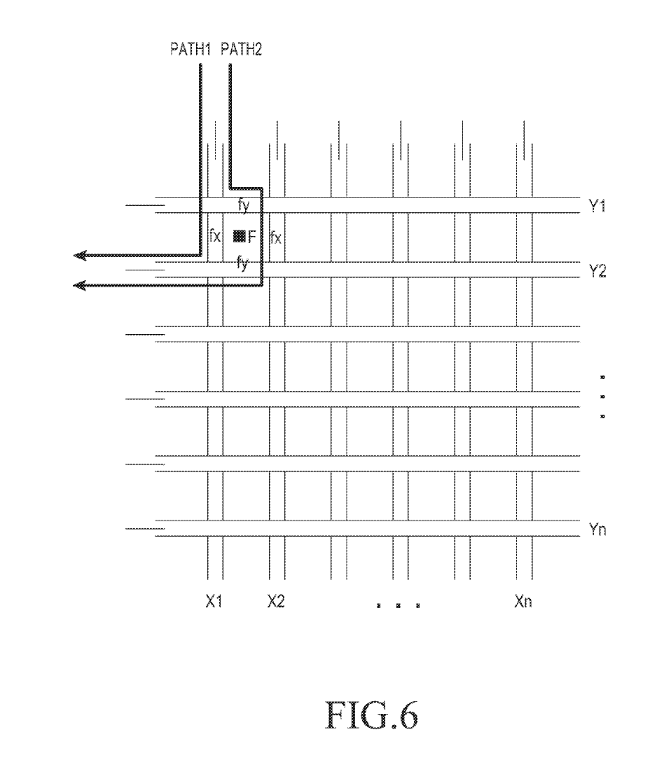

FIG. 6 illustrates the creation of multiple paths of a single touch according to an embodiment of the present invention.

Referring to FIG. 6, after a single touch, due to a pressure F of the touch, pressures of fx and fy are transferred to the first and second X-axis sensor lines X1 and X2 and the first and second Y-axis sensor lines Y1 and Y2 adjacent to the touch point, respectively. Due to the pressures of fx and fy, resistance values of column 1 and row 1, sensing points of column 1 and row 2, column 2 and row 1, and column 2 and row 2 vary.

A method of scanning a voltage value of the second Y-axis sensor line Y2 will be described below.

When the first X-axis sensor line X1 is referenced, path 1 is a signal path via the sensing point of column 2 and row 1, and path 2 is a signal path via sensing points of column 1 and row 1, column 1 and row 2, and column 2 and row 2. When the touch panel is coupled to another element, a pressure may be applied to the touch panel. In this case, multiple paths may be formed by the sensing points to which a pressure is applied, and a coordinate error may be generated due to the multiple paths.

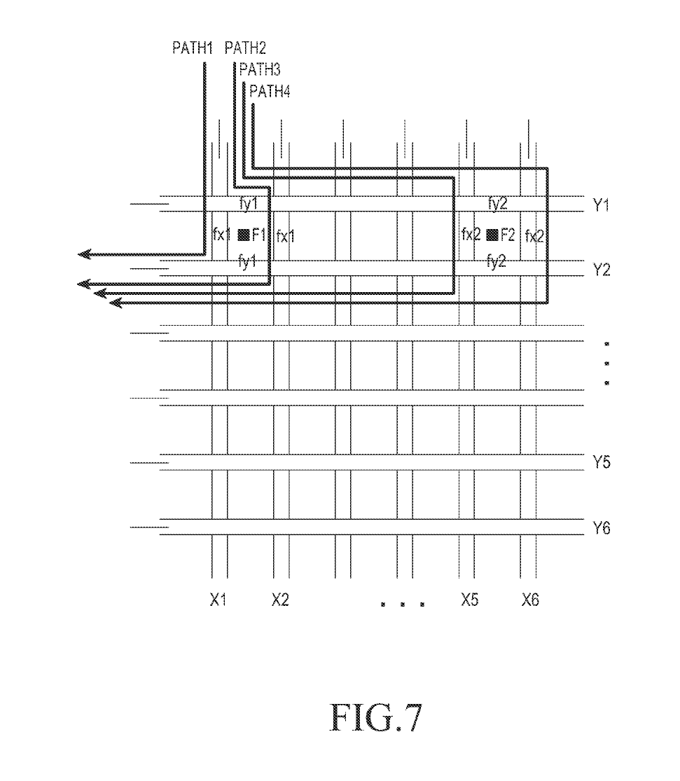

FIG. 7 illustrates the creation of multiple paths of multiple touches according to an embodiment of the present invention.

Referring to FIG. 7, after multiple touches, due to a pressure F 1 by a first touch, pressures of fx1 and fy1 are transferred to the first and second X-axis sensor lines X1 and X2 and the first and second Y-axis sensor lines Y1 and Y2 adjacent to a first touch point. Due to the pressures of fx1 and fy1, resistance values of sensing points column 1 and row 1, column 1 and row 2, column 2 and row 1, and column 2 and row 2 vary. Due to a pressure F2 by a second touch, pressures of fx2 and fy2 are transferred to the fifth and sixth X-axis sensor lines X5 and X6 and the first and second Y-axis sensor lines Y1 and Y2 adjacent to a second touch point. Due to the pressures of fx2 and fy2, resistance values of the sensing points of column 1 and row 5, column 1 and row 6, column 2 and row 5, and column 2 and row 6 vary.

A case of scanning a voltage value of the second Y-axis sensor line Y2 will be described below.

When the first X-axis sensor line X1 is referenced, path 1 is a signal path via the sensing point column 2 and row 1, and path 2 is a signal path via the sensing points of column 1 and row 1, column 1 and row 2, and column 2 and row 2. The third path is a signal path via the sensing points of column 2 and row 1, column 1 and row 5, and column 2 and row 5, and the fourth path is a signal path via the column 1 and row 1, column 1 and row 6, and column 2 and row 6.

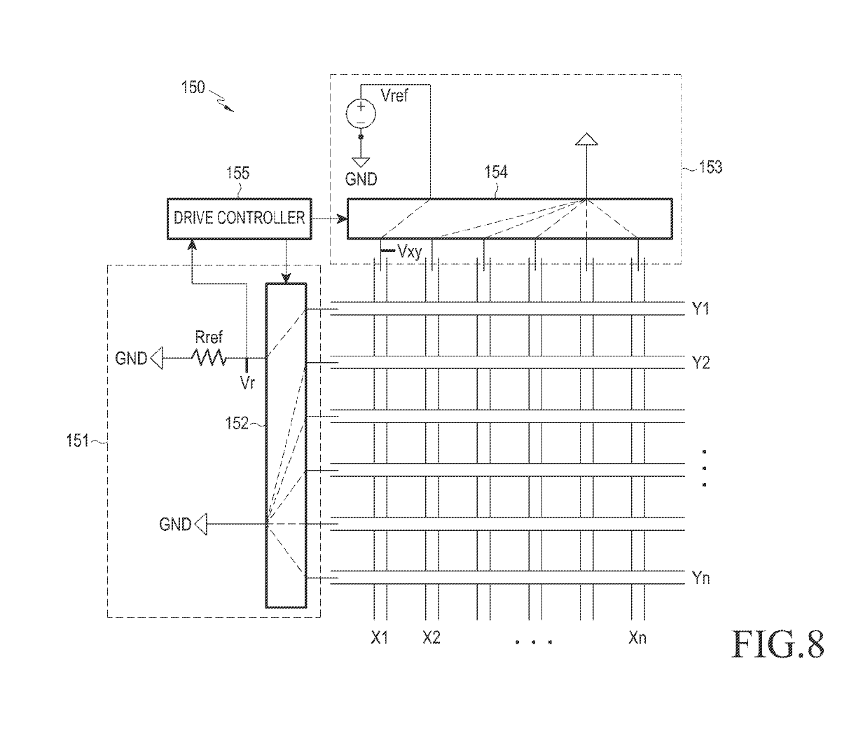

FIG. 8 illustrates a drive unit according to an embodiment of the present invention.

Referring to FIG. 8, the drive unit 150 includes an X-axis drive (that is, a first axis drive) 153, a Y-axis drive (that is, a second axis drive) 151, and a drive controller 155.

The X-axis drive 153 includes an X-axis switch (that is, a first axis switch or a first switch) 154, which sequentially applies a reference voltage Vref to the first to n-th X-axis sensor lines X1 to Xn. The application of the reference voltage is conducted by a voltage source.

The X-axis switch 154 is a 2*n switch including n voltage applying terminals connected to the first to n-th X-axis sensor lines X1 to Xn at one end thereof, and a voltage source connecting terminal and a ground connecting terminal at an opposite end thereof. The X-axis switch 154 sequentially applies a reference voltage Vref to the X-axis sensor lines X1 to Xn under the control of the drive controller 155, and at an arbitrary time point, the reference voltage Vref is applied to one X-axis sensor line and the remaining X-axis sensor lines are connected to the ground voltage.

The Y-axis drive 151 includes a Y-axis switch (that is, a second axis switch or a second switch), which sequentially scans voltage values of the first to n-th Y-axis sensor lines Y1 to Yn. The Y-axis switch 152 is a 2*n switch including n voltage scanning terminals connected to the first to n-th Y-axis sensor lines Y1 to Yn at one end thereof, and a voltage detecting terminal and a ground connecting terminal at an opposite end thereof. The Y-axis switch 152 sequentially scans voltages from the Y-axis sensor lines Y1 to Yn under the control of the drive controller 155, and at an arbitrary time point, a voltage of one Y-axis sensor line is scanned and the remaining Y-axis sensor lines are connected to the ground voltage. The reference resistance Rref is connected to the voltage detecting terminal, and the drive controller 155 detects a voltage applied to the reference resistance Rref.

A case of scanning a voltage value Vxy of a sensing point of column 1 and row 1 where the first X-axis sensor line X1 and the first Y-axis sensor line Y1 cross each other will be described below.

A reference voltage Vref is applied only to the first X-axis sensor line X1, and the remaining X-axis sensor lines are connected to the ground voltage. Only the first Y-axis sensor line Y1 is connected to a reference resistance Rref, and the remaining second to n-th Y-axis sensor lines Y2 to Yn are connected to the ground voltage. A voltage applied to the first X-axis sensor line X1 is a scan signal, and a voltage value Vxy output through the first Y-axis sensor line Y1 is a detection signal. A voltage value Vxy of the sensing point of column 1 and row 1 is a voltage value other than the voltage value Vr of the reference resistance Rref at the reference voltage Vref. That is, the voltage value Vxy of the sensing point of column 1 and row 1 is a voltage value applied to the resistance Rxy at a contact portion of the first and second resistance layers.

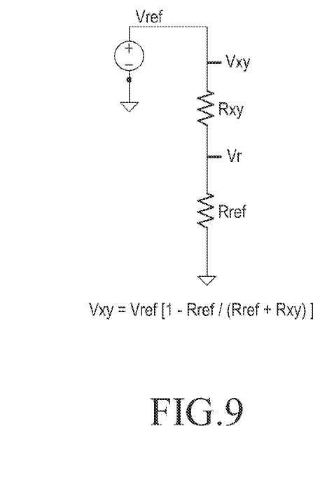

FIG. 9 illustrates a voltage scanning method according to an embodiment of the present invention.

Referring to FIG. 9, a voltage value Vxy at a sensing point of column 1 and row 1 is calculated based on a reference voltage Vref, a reference resistance Rref, and a resistance Rxy of the sensing point as follows. For example, the voltage value Vxy may be calculated as shown below in Equation (2).

Vxy=Vref[1+Rref/(Rref+Rxy)] (2)

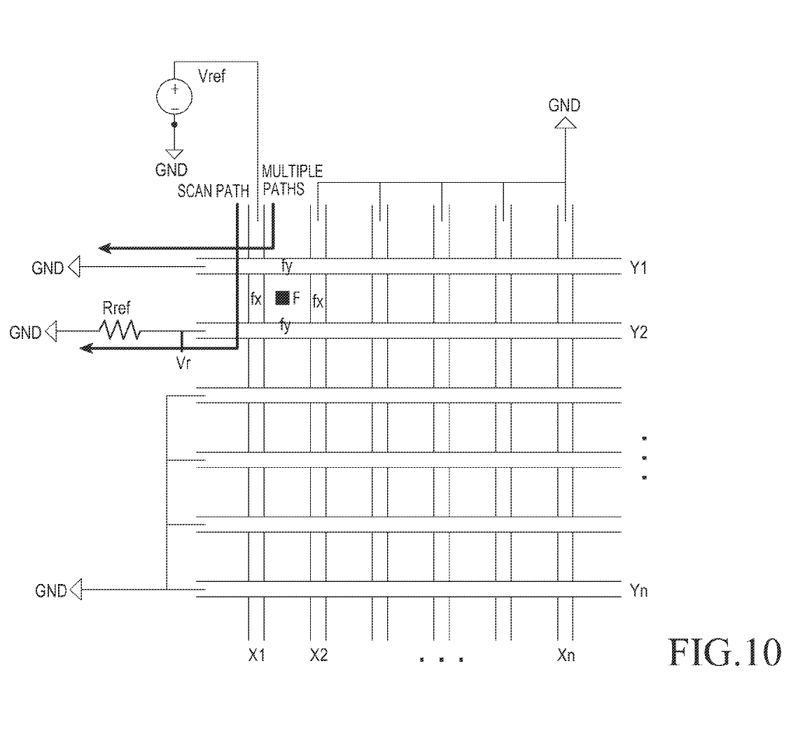

FIG. 10 illustrates a method of restraining multiple paths of a single touch according to an embodiment of the present invention.

Referring to FIG. 10 after a single touch, due to a pressure F by a touch, pressures of fx and fy are transferred to the first and second X-axis sensor lines X1 and X2 and the first and second Y-axis sensor lines Y1 and Y2 adjacent to a touch point, respectively. Due to the pressures of fx and fy, the resistance values of the sensing points of column 1 and row 1, column 1 and row 2, column 2 and row 1, and column 2 and row 2 vary.

A case of scanning a voltage of a sensing point of column 2 and row 1 will be described below.

First, by the X-axis drive 153, a reference voltage Vref is applied to the first X-axis sensor line X1, and the remaining X-axis sensor lines X2 to Xn are connected to the ground voltage. By the Y-axis drive 151, only the second Y-axis sensor line Y2 is connected to a reference voltage Rref, and the remaining Y-axis sensor lines Y2 to Yn are connected to the ground voltage.

The scan path is a signal path via the sensing point of column 2 and row 1. Because the multiple paths via the sensing point of column 1 and row 1 are connected to the ground voltage, a noise signal on the multiple paths is not output through the second Y-axis sensor line Y2.

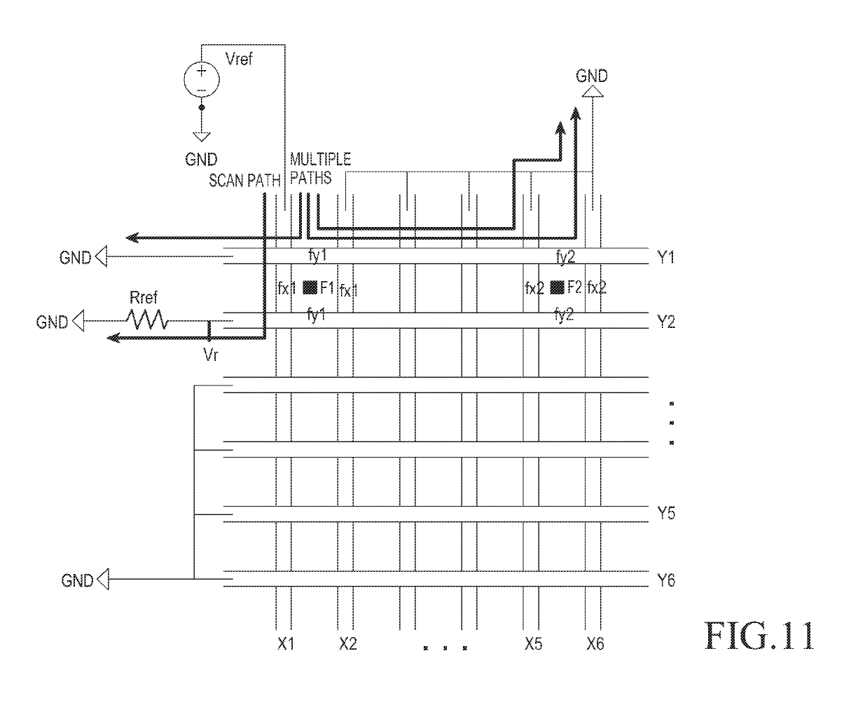

FIG. 11 illustrates a method of restraining multiple paths of multiple touches according to an embodiment of the present invention.

Referring to FIG. 11, after multiple touches, due to a pressure F 1 by a first touch, pressure of fx1 and fy1 are transferred to the first and second X-axis sensor lines X1 and X2 and the first and second Y-axis sensor lines Y1 and Y2 adjacent to a first touch point. By pressures of fx1 and fy1, resistance values of sensing points of column 1 and row 1, column 1 and row 2, column 2 and row 1, and column 2 and row 2 vary. Due to a pressure F2 by a second touch, pressures of fx2 and fy2 are transferred to the fifth and sixth X-axis sensor lines X5 and X6 and the first and second Y-axis sensor lines Y1 and Y2 adjacent to the second touch point, respectively. By the pressures of fx2 and fy2, the resistance values of the sensing points of column 1 and row 5, column 1 and row 6, column 2 and row 5, and column 2 and row 5 vary.

A case of scanning a voltage value of a sensing point of column 2 and row 1 will be described below.

A scan path is a signal path via the sensing point of column 2 and row 1. Because multiple paths via the sensing point of column 1 and row 1 are connected to the ground voltage, a noise signal on the multiple paths is not output through the second Y-axis sensor line Y2. Because the second multiple paths via sensing points of column 1 and row 1 and column 1 and row 5 are connected to the ground voltage, a noise signal on the second multiple paths is not output through the second Y-axis sensor line Y2. Because the third multiple paths via sensing points of column 1 and row 1 and column 1 and row 6 are connected to the ground voltage, a noise signal on the third multiple paths is not output through the second Y-axis sensor line Y2.

Although embodiment of the present invention have bee described above with a reference resistance included in the Y-axis drive 151, the reference resistance may be included in the X-axis drive 153 and the drive controller 155 may detect a voltage of a reference resistance in a method described with reference to FIGS. 5A and 5B.

As described above, the embodiments of the present invention restrain a multiple path effect in a photosensitive touch panel used as an input unit of a flexible device to minimize an error generated, when a touch coordinate is calculated. Further, the present invention effectively restrains multiple paths after a single touch and multiple touches, and restrains a multiple path effect of influencing a path to which a pressure by a touch is transferred, even if an intended pressure exists when a pressure sensitive touch panel is mounted to an electronic device, such as a portable terminal, thereby minimizing a coordinate calculating error of a touch point as well.

While the present invention has been particularly shown and described with reference to certain embodiments thereof, it will be understood by those of ordinary skill in the art that various changes in form and details may be made therein without departing from the spirit and scope of the present invention as defined by the following claims and their equivalents.

What is claimed is:

1. A pressure sensitive touch panel comprising:
first sensor lines arranged along a first axis;
second sensor lines arranged along a second axis that cross the first axis;
a drive unit that sequentially applies a scan signal to the first sensor lines, and sequentially detects detection signals of the second sensor lines; and
a controller that controls the drive unit to selectively apply the scan signal to one of the first sensor lines and to selectively detect a detection signal from one of the second sensor lines.

2. The pressure sensitive touch panel of claim 1, wherein the drive unit comprises:
a first switch that applies the scan signal to the one of the first sensor lines and connects remaining ones of the first sensor lines to a ground voltage; and
a second switch that selectively detects a detection signal from the one of the second sensor lines and connects remaining ones of the second sensor lines to the ground voltage.

3. The pressure sensitive touch panel of claim 1, wherein the first axis and the second axis are perpendicular to each other.

4. The pressure sensitive touch panel of claim 1, wherein each of the first and second sensor lines comprises a conductive electrode line and a resistance layer laminated on the electrode line.

5. The pressure sensitive touch panel of claim 1, wherein the controller determines a touch point, based on a difference between a voltage of the scan signal and a voltage of the detection signal.

6. A portable terminal including a pressure sensitive touch panel comprising:
first sensor lines arranged along a first axis;
second sensor lines arranged along a second axis that cross the first axis;
a drive unit that sequentially applies a scan signal to the first sensor lines, and sequentially detects detection signals of the second sensor lines; and
a controller that controls the drive unit to selectively apply the scan signal to one of the first sensor lines and to selectively detect a detection signal from one of the second sensor lines.

7. The portable terminal of claim 6, further comprising a display unit that displays an image.

8. The portable terminal of claim 7, wherein the touch panel and the display unit are flexible.

9. The portable terminal of claim 6, wherein the drive unit comprises:
a first switch that applies the scan signal to the one of the first sensor lines and connects remaining ones of the first sensor lines to a ground voltage; and
a second switch that selectively detects a detection signal from the one of the second sensor lines and connects remaining ones of the second sensor lines to the ground voltage.

10. The portable terminal of claim 6, wherein the first axis and the second axis are perpendicular to each other.

11. The portable terminal of claim 6, wherein each of the first and second sensor lines comprises a conductive electrode line and a resistance layer laminated on the electrode line.

12. The portable terminal of claim 6, wherein the controller determines a touch point, based on a difference between a voltage of the scan signal and a voltage of the detection signal.
